(19) United States
(12) Patent Application Publication
(10) Pub. No.: US 2005/0109092 A1
(43) Pub. Date: May 26, 2005

(54) System and method for determining tire position

(75) Inventors: Carlos Efrain Martinez Marrufo, Guadalajara (MX); Victor Rodrigo Jauregui Sandoval, Zapopan (MX); Jorge Antonio Vazquez Murillo, Zapopan Jalisco (MX); Gerardo Echeagaray Camacho, Tlaquepaque Jalisco (MX)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/993,130

(22) Filed: Nov. 19, 2004

Related U.S. Application Data
(60) Provisional application No. 60/524,155, filed on Nov. 21, 2003.

(51) Int. Cl. G01M 17/02

(52) U.S. Cl. 73/146

(57) ABSTRACT

A tire pressure monitoring system and method uses a power characteristic of a radio frequency signal, from a tire sensor to determine the location of the tire associated with that signal. The location of the antenna relative to the sensor and relative to a receiver in a central module creates a unique power characteristic for each antenna. Thus, it is possible to link a given signal with a particular tire position based on the power characteristic of that signal without requiring additional hardware or calibration processes.

### REFERENCE TO RELATED APPLICATION

The present invention claims the benefit of U.S. Provisional Patent Application No. 60/524,155, filed Nov. 21, 2003.

### TECHNICAL FIELD

The present invention relates to a tire location detection system, and more particularly to a method and system for determining the location of an object in a vehicle.

### BACKGROUND OF THE INVENTION

Vehicles often incorporate tire pressure monitoring systems to alert the user when the pressure in one or more of the tires falls below a desired level. These pressure monitoring systems make it more convenient for the user to detect when a tire is in a low pressure condition because the user no longer needs to remember to check tire pressure manually. Currently-known systems include tire pressure sensors that are associated with each tire.

To provide the tire pressure information to the user, however, the monitoring system must include extra hardware and calibration processes to enable the user to correlate a given sensor with a particular tire location. For example, additional hardware may be placed in the chassis near each tire to allow the sensor to activate (e.g., by a low frequency signal) and transmit its pressure information to a central module. The central module correlates the tire location when it receives the tire pressure information by controlling the additional hardware. The additional devices trigger the tire pressure sensors by a low range, low frequency RF signal. Thus, the central module is able to command a particular sensor associated with a given position to transmit information.

A unique identification code may be assigned to each tire during a calibration process so that the central module can identify the position of a given tire. If the calibration is conducted manually by the vehicle manufacturer or dealer, no additional hardware is needed. However, the central module must be recalibrated each time the tire positions change (e.g., during rotation) or if a tire is changed, requiring the user to return to the dealer to conduct the recalibration.

Another proposed system includes mounting four receiver antennas, one antenna for each tire, close to each wheel so that the power of the signal generated by one of the sensors is filtered. However, this approach also requires extra hardware for multiplexing the input of the antennas to the central module.

There is a desire for a tire pressure monitoring system and method that can detect a tire pressure sensor position without extra hardware or calibration.

### SUMMARY OF THE INVENTION

The invention is directed to a tire position location system and method that uses a power characteristic of a wirelessly transmitted signal, such as a radio frequency signal, from a tire sensor to determine the location of the tire associated with that signal. Each tire has a sensor having an antenna associated with it. The location of the sensor antenna relative to a receiver in a central module creates a unique power characteristic for each antenna. Thus, it is possible to link a given signal with a particular tire location based on the power characteristic of that signal.

By correlating the power characteristic of a signal with a tire location, it is possible to determine the location of the tire associated with that signal without requiring additional tire identification information. Moreover, because the signal depends on tire location and not on the specific tire, there is no need to recalibrate the system when the positions of the tires or the tires themselves change.

### BRIEF DESCRIPTION OF THE DRAWINGS

FIG. 1 is a diagram illustrating underlying concepts used by one embodiment of the invention;

FIG. 2 is a block diagram representing components in a tire pressure monitoring system according to one embodiment of the invention;

FIG. 3 is a flow diagram illustrating a method used by the tire pressure monitoring system according to one embodiment of the invention.

### DETAILED DESCRIPTION OF THE PREFERRED EMBODIMENT

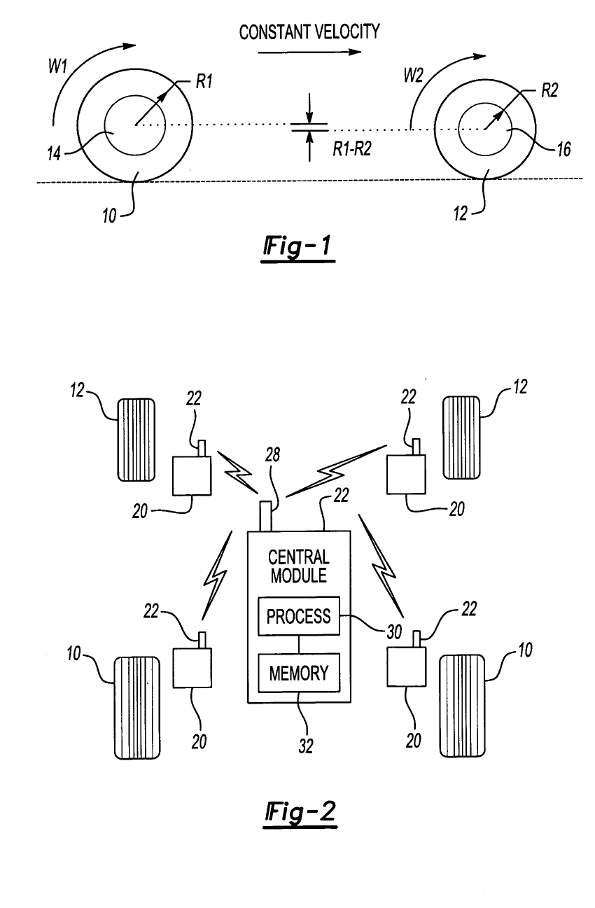

FIG. 1 is a schematic diagram that illustrates the concepts used by the invention to detect low tire pressure according to one embodiment of the invention. In this illustration, it is assumed that a rear tire 10 is inflated to a proper pressure and a front tire 12 has low pressure. The rear and front tires 10, 12 in a vehicle are rotatable about rear and front wheels 14, 16, respectively. Because the front tire 12 has a lower pressure, the radius of the front tire 12 has a smaller radius R2 than the radius R1 of the properly inflated rear tire 10.

The linear velocity of a given wheel 14, 16 will always be known because it corresponds to the speed of the vehicle. The linear velocity of the rear wheel 14 and the front wheel 16 will always be the same. However, because the radii R1 and R2 are different due to the different tire pressures, the angular velocity w of the front wheel 16 and front tire 10 will be greater than the angular velocity of the rear wheel 14 and rear tire 10. More particularly, because ω=v/r, where is the linear velocity and r is the radius, the smaller radius R2 of the front tire 12 will cause the front wheel 16 to rotate faster than the rear wheel 14.

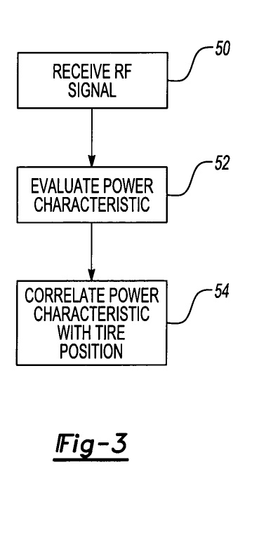

Referring to FIG. 2, each tire 10, 12 has an associated sensor 20 that measures the angular velocity of the tire and transmits an RF signal indicating the angular velocity of its corresponding tire 10, 12 to a central module 22 via an associated antenna 24. Note that the sensor 20 may already exist in, for example, an ABS system. In one embodiment, the sensor 20 is a device that generates an RF signal output. The central module 22 itself has a receiver 28 that receives the signals from the sensors 20 and a processor 30 that evaluates the sensor signals.

If all of the tires 10, 12 are properly inflated to equal pressures, each sensor 20 will output the same RF signal because each wheel 14, 16 will have the same angular velocity. If one or more of the tires 10, 12 is under-inflated (e.g., the front tire 12 in FIG. 1), however, the reduced radius of the under-inflated tire 12 will cause the under-inflated tire 12 to rotate faster than the other tires. The sensor 20 associated with the under-inflated tire will therefore output an RF signal indicating the increased angular velocity to the receiver 28 of the central module 22.

The processor 30 may run a data correlation algorithm that correlates the angular speed of each tire with a specific tire pressure via, for example, a look-up table containing empirically-derived data and/or functions linking the angular speed and tire pressure. The processor 30 may also compare the angular velocity of each wheel with a maximum threshold corresponding to a minimum desirable tire pressure. Alternatively, or in addition, the processor 20 compares the angular velocities of each tire 10, 12 to detect if one of the tires has a faster angular velocity than the other three tires.

By comparing the angular velocities of the tires, either with each other or with a threshold, the central module 22 can detect whether any of the tire has a pressure drop that is sufficient to change the radius of the tire and therefore the angular velocity of its corresponding wheel. The algorithm may take into account other factors, such as tire friction, vehicle turning and braking, etc.) in determining whether a given angular velocity indicates an undesirably low tire pressure.

Detecting the existence of a low pressure tire is insufficient without a way to identify the location of the tire. To do this without the inconvenience of currently known tire location/identification systems, the central module 22 infers the location of each tire based on a power characteristic of the RF signal for each tire.

The receiver 28 of the central module 22 is positioned such that the power characteristic of the RF signal transmitted by each antenna 24 will be different. More particularly, the position of each antenna 24 will affect the power characteristic of the RF signal from that antenna 24 based on its distance from the receiver 28.

Because the antennas 24 are at different distances and positions relative to the receiver 28, the processor 30 can correlate a given power characteristic with a given tire position. Each antenna 24 will output an RF signal having a different power characteristic even when the RF signals for each tire are the same (i.e., if all four tire sensors have the same transmission). Note that the power characteristics are based on the locations of the tires 10, 12 and not the specific tire itself. Thus, if one of the RF signals indicates a tire pressure that is higher or lower than a desired threshold (indicating tire pressure problem), it is possible to identify which tire has the problem by simply checking the power characteristic of the RF signal and correlating that power characteristic with the tire location.

As shown in FIG. 3, the processor 30 receives the RF signal from at least one of the sensors 20 via its associated antenna 24 (block 50) and evaluating the power characteristic of the signal (block 52). In one embodiment, the processor 30 compares the power characteristic of the signal with at least one reference power characteristic. The central module 22 may include a memory 32 that stores four reference power characteristics, one for each tire location in the vehicle (FIG. 2). The processor 30 can therefore correlate the power characteristic of the RF signal it receives with the location of the tires 10, 12 associated with the signal (block 54).

If the tires are changed or rotated, there is no need for a recalibration because the power characteristic of the RF signal does not depend on the characteristics of the tire itself. Instead, the power characteristic depends only on the location of the antenna 24 relative to the sensor 22 and to the receiver 28. By using the power characteristic of the RF signal sent to the central module to determine tire location, the invention eliminates the need to include extra hardware for controlling (e.g., synchronizing) the tire sensor transmissions and also eliminates extra tire identification calibration steps during the manufacturing process and updates during tire position changes.

It should be understood that various alternatives to the embodiments of the invention described herein may be employed in practicing the invention. It is intended that the following claims define the scope of the invention and that the method and apparatus within the scope of these claims and their equivalents be covered thereby.

1. A tire location monitoring system, comprising:
at least one sensor that generates a signal corresponding to at least one tire; and
a receiver that receives the signal; and
a processor that determines a location of the sensor based on a power characteristic of the signal.

2. The system of claim 1, wherein said at least one sensor comprises a plurality of sensors, each sensor generating a signal having a unique power characteristic according to its location in a vehicle.

3. The system of claim 2, wherein the processor detects which one of said plurality of sensors sent the signal by correlating the unique power characteristic with one of said plurality of sensors.

4. The system of claim 2, wherein the unique power characteristic is dependent on a position of each of said plurality of sensors relative to the receiver.

5. The system of claim 2, further comprising a memory containing a plurality of reference power characteristics, each reference power characteristic corresponding to a different location, wherein the processor determines the location of the sensor by comparing the power characteristic of the signal received by the receiver with said plurality of reference power characteristics.

6. The system of claim 1, further comprising a memory containing at least one reference power characteristic, wherein the processor determines the position of the sensor by comparing the power characteristic of the signal received by the receiver with the reference power characteristic.

7. A tire location monitoring method, comprising:
generating a signal corresponding to at least one tire; and
determining a location of the tire in a vehicle based on a power characteristic of the signal.

8. The method of claim 7, wherein said at least one tire comprises a plurality of tires, each tire having an associated signal with a unique power characteristic, and wherein the determining step comprises correlating the unique power characteristic with the location of one of said plurality of tires in the vehicle.

9. The method of claim 7, wherein the determining step comprises comparing the power characteristic of the signal with a plurality of reference power characteristics, each reference power characteristic corresponding to a unique location in the vehicle.

10. The method of claim 1, wherein the determining step comprises comparing the power characteristic of the signal received by the receiver with a reference power characteristic.
